(19) United States
(12) Patent Application Publication
(10) Pub. No.: US 2007/0061351 A1
(43) Pub. Date: Mar. 15, 2007

(54) Shape object text

(75) Inventors: Shawn A. Villaron, San Jose, CA (US); Aleksandr Gil, Redmond, WA (US); Dachuan Zhang, Sunnyvale, CA (US); Jonathan P. Schoeller, Sunnyvale, CA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/479,983

(22) Filed: Jun. 30, 2006

Related U.S. Application Data
(63) Continuation-in-part of application No. 11/228,616, filed on Sep. 15, 2005.
(63) Continuation-in-part of application No. 11/228,617, filed on Sep. 15, 2005.
(63) Continuation-in-part of application No. 11/228,867, filed on Sep. 15, 2005.
(60) Provisional application No. 60/716,711, filed on Sep. 13, 2005.

(51) Int. Cl. G06F 7/00

(52) U.S. Cl. 707/101

(57) ABSTRACT

A transparent format can be used to store the content of shape objects so that documents authored by different types of applications can uniformly share information related to the shape objects. Shape objects comprise, for example, text runs that have properties such as font, style, color, size and the like. The shape objects can be hierarchically represented such that principles of object oriented programming can be applied to the text run properties. The transparent format allows enhanced control of information when the format is not, for example, in a proprietary binary format.

### RELATED APPLICATIONS

The present application is a continuation-in-part of U.S. patent application No. 11/228,616, filed Sep. 15, 2005, which is incorporated by reference and claims the benefit of the earlier filing date under 35 U.S.C. § 120.

The present application is a continuation-in-part of U.S. patent application No. 11/228,617, filed Sep. 15, 2005, which is incorporated by reference and claims the benefit of the earlier filing date under 35 U.S.C. § 120.

The present application is a continuation-in-part of U.S. patent application No. 11/228,867, filed Sep.15, 2005, which is incorporated by reference and claims the benefit of the earlier filing date under 35 U.S.C. § 120.

This utility patent application claims the benefit under 35 United States Code § 119(e) of U.S. Provisional patent application No. 60/716,711 filed on Sep. 13, 2005, which is hereby incorporated by reference in its entirety.

### COMPUTER PROGRAM LISTING APPENDIX

A computer program listing appendix on compact disc is included in the application. The computer program listing appendix includes sample schema files (“.XSD”) representing aspects (for example) of a word processing application and associated documents described herein.

### BACKGROUND

The extensible markup language (XML) format being introduced and now widely adopted has been transforming the landscape of computer programming. XML has a number of advantages over previous programming languages.

The XML format is considered an accessible format that allows other developers to see the storage details (such as data types, restrictions, relationships, values, and the like) of content represented in such a format. The interoperability of XML programs is also an advantage. Solutions can alter information inside a document or create a document entirely from scratch by using standard tools and technologies capable of manipulating XML.

Many documents today are authored using proprietary software that stores the documents in proprietary formats. The proprietary formats render the documents difficult to read by other programs, whether the programs are different kinds of programs (such as spreadsheet or word processors) or written by different vendors.

Furthermore the proprietary formats make it difficult to control the ownership of data (for example, by retaining data in the file even after it is deleted. It is also often difficult to ensure uniformity when sharing data between documents authored by differing application types because the document files have different formats. Even merely trying to identify what data is stored in a proprietary format can be difficult.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

The present disclosure is directed to providing a transparent format for content (such as text) of shape objects whereby documents authored by different types of applications can uniformly share information. Shape objects comprise, for example, text that has properties such as font, style, color, size and the like. Text can be embodiment in text objects that can be used to represent individual characters, text runs, paragraphs, and the like. Characters can comprise ASCII codes, Asian characters, and the like.

The text runs are hierarchically represented such that principles of object oriented programming can be applied to the text run properties. For example, elements and attributes can be created in a markup language and used to enforce a property (such as “bold”) for text runs within regions defined by the elements. Thus properties such as encapsulation and inheritance can be applied.

The shape objects can be represented using a markup language, such as XML, to increase the transparency of the authored documents, increase the control of information, and to facilitate the transfer of data between dissimilar programs, such as between a word processing program and a spreadsheet program.

Additionally, a schema can be used to define and enforce rules for storing text runs within shape objects. The schema can be used by programs of differing types to ensure uniform handling of shared data. Likewise, the schema can be used to help recover from corrupted document files.

These and other features and advantages will be apparent from a reading of the following detailed description and a review of the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. Furthermore, various operating systems and applications can be used to provide a system providing thematic graphical objects. The disclosure herein is, therefore, not to be taken in a limiting sense.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a computing system architecture illustrating a computing apparatus utilized in and provided by various illustrative embodiments.

FIGS. 2a-2c are block diagrams illustrating a document relationship hierarchy for various modular parts utilized in a file format for representing a word processor document according to various illustrative embodiments.

FIGS. 3-5 are illustrative routines performed in representing documents in a modular content framework according to illustrative embodiments.

### DETAILED DESCRIPTION

As briefly described above, embodiments are directed to providing common document themes for graphic objects whereby documents authored by different types of applications can have a relatively uniform appearance. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

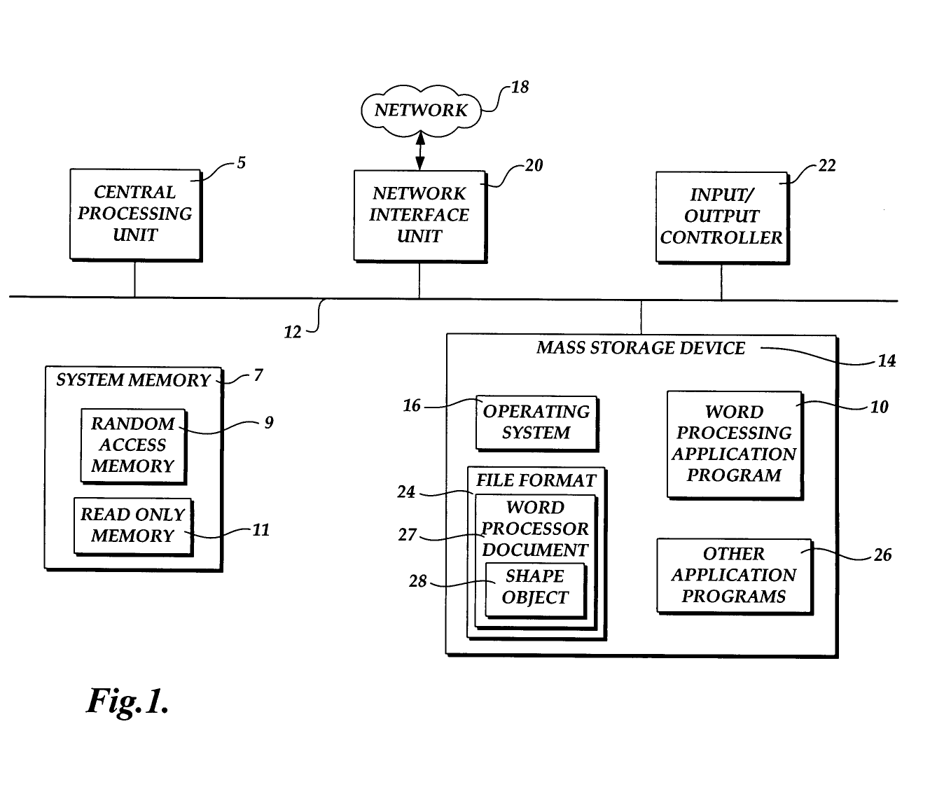

Referring now to the drawings, in which like numerals represent like elements, various aspects will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including handheld devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer utilized in an embodiment will be described. The computer architecture shown in FIG. 1 illustrates a computing apparatus, such as a server, desktop, laptop, or handheld computing apparatus, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVJS’), or other optical storage, magnetic cassettes, magnetic tape, magnetic disk storage or other magnetic storage devices, or any other medium which can be used to store the desired information and which can be accessed by the computer 2.

According to various embodiments, the computer may operate in a networked environment using logical connections to remote computers through a network 18, such as the Internet. The computer 2 may connect to the network 18 through a network interface unit 20 connected to the bus 12. It should be appreciated that the network interface unit 20 may also be utilized to connect to other types of networks and remote computer systems. The computer 2 may also include an input/output controller 22 for receiving and processing input from a number of other devices, including a keyboard, mouse, or electronic stylus (not shown in FIG. 1). Similarly, an input/output controller 22 may provide output to a display screen, a printer, or other type of output device.

As mentioned briefly above, a number of program modules and data files may be stored in the mass storage device 14 and RAM 9 of the computer 2, including an operating system 16 suitable for controlling the operation of a networked personal computer. The mass storage device 14 and RAM 9 may also store one or more program modules. In particular, the mass storage device 14 and the RAM 9 may store a word processing application program 10. The word processing application program 10 is operative to provide functionality for the creation and structure of a word processor document, such as a document 27, in an open file format 24, such as an XML file format and/or a binary file format. According to one embodiment, the word processing application program 10 and other application programs 26 comprise a suite of application programs including word processor, spreadsheet, and slide presentation authoring application programs. As discussed in greater detail below, the format of shape object 28 can be understood, displayed, and modified by programs in the application suite.

Embodiments greatly simplify and clarify the organization of document features and data. The word processing program 10 organizes the ‘parts’ of a document (features, data, themes, styles, objects, and the like) into logical, separate pieces, and then expresses relationships among the separate parts. These relationships, and the logical separation of ‘parts’ of a document, make up a new file organization that can be easily accessed, such as by a developer's code. It should be understood that the following description is made in terms of a word processing program 10 and associated documents, but that embodiments are equally applicable to other applications and associated documents, for example, spreadsheet applications and documents, slide presentation applications and documents, and the like.

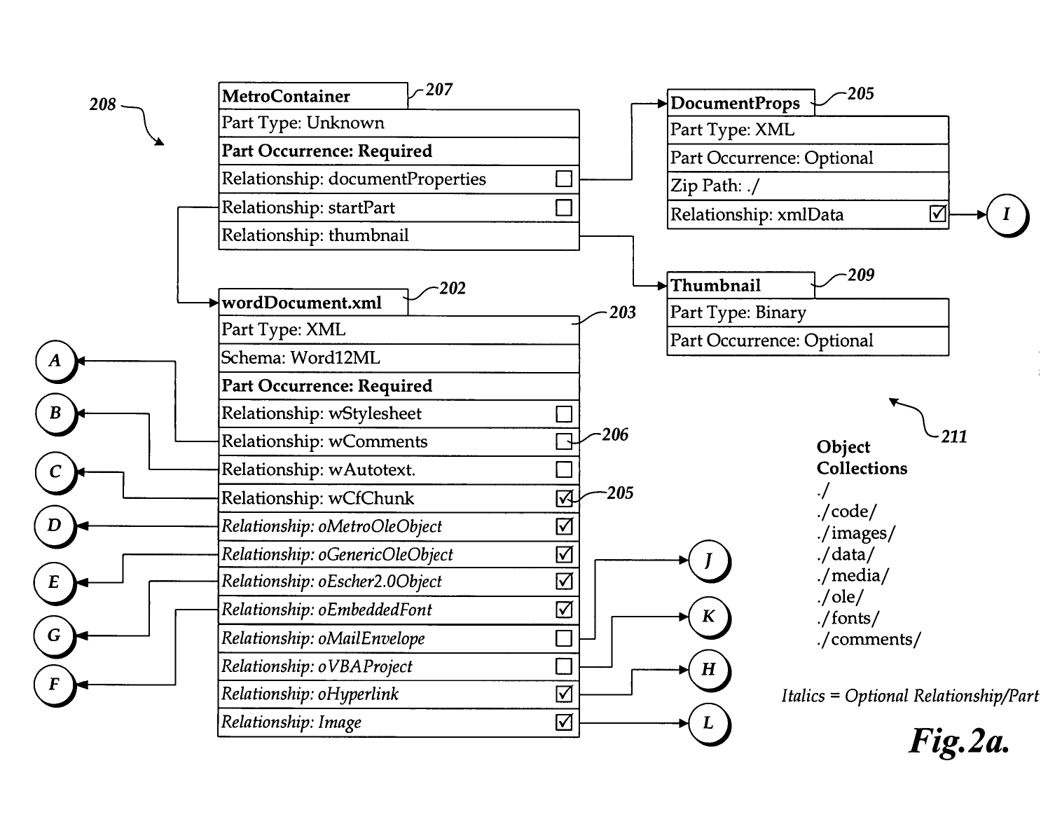

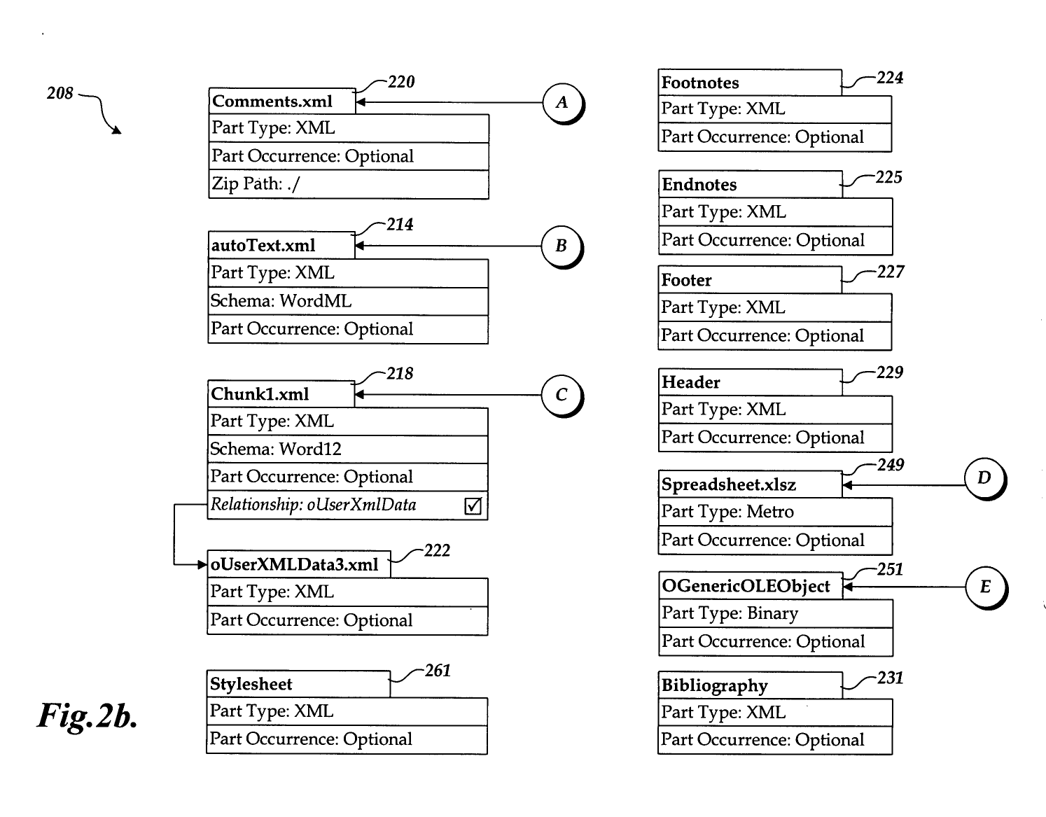

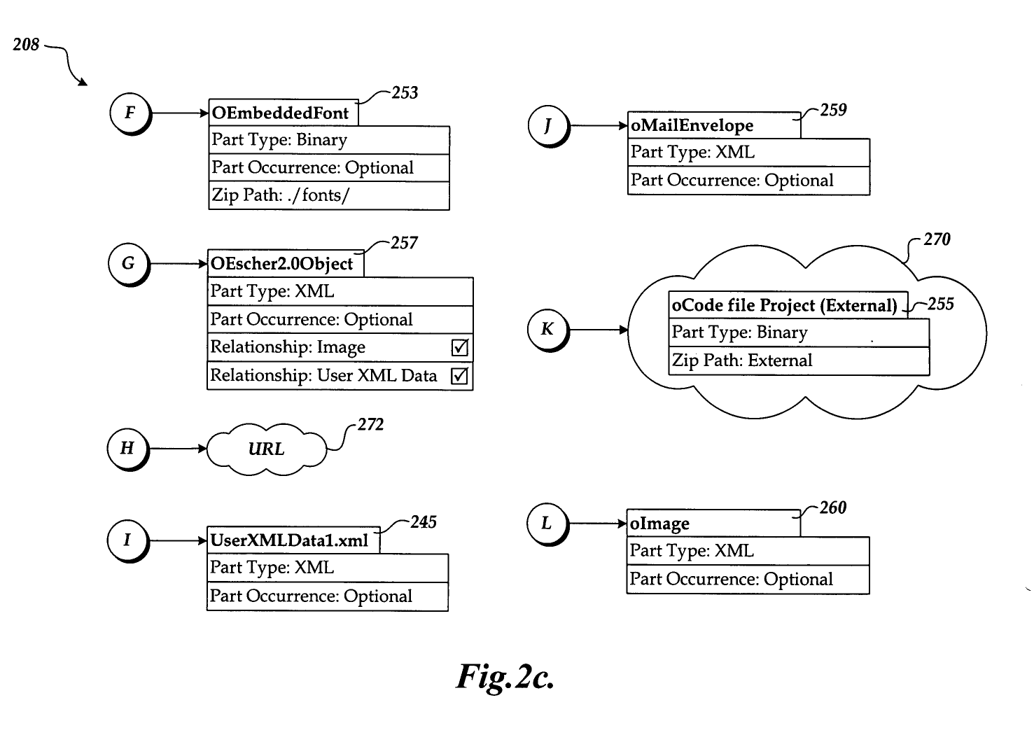

Referring now to FIGS. 2a-2c, block diagrams illustrating a word processor document relationship hierarchy 208 for various modular parts utilized in the file format 24 for representing a document according to various illustrative embodiments will be described. The word processor document relationship hierarchy 208 lists specific file format relationships, some with an explicit reference indicator 205 indicating an explicit reference to that relationship in the content of the modular part, for example via a relationship identifier. An example of this would be an image part 260 referenced by a parent or referring part that references the modular parts with which the parent part has a relationship. In some embodiments, it may not be enough to just have the relationship to the image part 260 from a parent or referring modular part, for example from a document part 202. The parent part may also need to have an explicit reference to that image part relationship inline so that it is known where the image goes. Non-explicit indicators 206 indicate that a referring modular part is associated, but not called out directly in the parent part's content. An example of this would be a theme object and/or stylesheet 261 where it is implied that there is always a stylesheet associated, and therefore there is no need to call out the stylesheet 261 in the content. The stylesheet 261 can be found by merely looking for a relationship of that type. Optional relationships with respect to validation are indicated in italics.

The various modular parts or components of the presentation (for use by a word processor, for example) hierarchy 208 are logically separate but are associated by one or more relationships. Each modular part is also associated with a relationship type and is capable of being interrogated separately and understood with or without the word processing application program 10 and/or with or without other modular parts being interrogated and/or understood. Thus, for example, it is easier to locate the contents of a document because instead of searching through all the binary records for document information, code can be written to easily inspect the relationships in a document and find the document parts effectively ignoring the other features and data in the file format 24. Thus, the code is written to step through the document in a much simpler fashion than previous interrogation code. Therefore, an action such as removing all the images, while tedious in the past, is now less complicated.

A modular content framework may include a file format container 207 associated with the modular parts. The modular parts include the document part 202 operative as a guide for properties of the document. The document hierarchy 208 may also include a document properties part 205 containing built-in properties associated with the file format 24, and a thumbnail part 209 containing a thumbnail associated with the file format 24. It should be appreciated that each modular part is capable of being extracted from or copied from the document and reused in a different document along with associated modular parts identified by traversing relationships of the modular part reused. Associated modular parts are identified when the word processing application 10 traverses inbound and outbound relationships of the modular part reused.

Aside from the use of relationships in tying parts together, there is also a single part in every file that describes the content types for each modular part. This gives a predictable place to query to find out what type of content is inside the file. While the relationship type describes how the parent part will use the target part (such as “image” or “stylesheet”), the content or part type 203 describes what the actual modular part is (such as “JPEG” or “XML”) regarding content format. This assists both with finding content that is understood, as well as making it easier to quickly remove content that could be considered unwanted (for security reasons, etc.). The key to this is that the word processing application must enforce that the declared content types are indeed correct. If the declared content types are not correct and do not match the actual content type or format of the modular part, the word processing application should fail to open the modular part or file. Otherwise potentially malicious content could be opened.

Referring to FIG. 2b, other modular parts may include a comments part 220 containing comments associated with the document, an autotext part 214, for example a glossary containing definitions of a variety of words associated with the document, and a chunk part 218 containing data associated with text of the document. Still further, the modular parts may include a user data part 222 containing customized data capable of being read into the document and changed, a footnote part 224 containing footnotes associated with the document, and an endnote part 225 containing endnotes associated with the document.

Other modular parts include a footer part 227 containing footer data associated with the document, a header part 229 containing header data associated with the document and a bibliography part 231 containing bibliography data and/or underlying data of a bibliography associated with the document. Still further, the modular parts may include a spreadsheet part 249 containing data defining a spreadsheet object associated with the document, an embedded object part 251 containing an object associated with the document, and a font part 253 containing data defining a font associated with the document.

Referring to FIG. 2c, the modular parts also include a drawing object part 257 containing an object associated with the document where the drawing object is built using a drawing platform, a mail envelope part 259 containing envelope data where a user of the document has sent the document via electronic mail, a code file part 255 containing code associated with the document where the code file part is capable of being accessed via an external link 270, and a hyperlink part 272 containing a hyperlink associated with the document where the hyperlink part 272 includes a uniform resource locator.

Other modular parts may also include an embedded object part 253 containing an object associated with the document, a second user data part 245 containing customized data capable of being read into the file format container and changed. As an example, embodiments make it easier for a programmer/developer to locate an embedded object in a document because any embedded object has an embedded object part 253 separate in the file format 24 with corresponding relationships expressed. The embedded object part 253 as are other modular parts, is logically broken-out and separate from other features & data of the document. It should be appreciated that modular parts that are shared in more than one relationship are typically only written to memory once. It should also be appreciated that certain modular parts are global and thus, can be used anywhere in the file format. In contrast, some modular parts are non-global and thus, can only be shared on a limited basis.

In various embodiments, the file format 24 may be formatted according to extensible markup language (“XML”) and/or a binary format. As is understood by those skilled in the art, XML is a standard format for communicating data. In the XML data format, a schema is used to provide XML data with a set of grammatical and data type rules governing the types and structure of data that may be communicated. The XML data format is well-known to those skilled in the art, and therefore not discussed in further detail herein. The XML formatting closely reflects the internal memory structure. Thus, an increase in load and save speed is evident.

Embodiments allow documents to be more programmatically accessible. This enables a significant number of new uses that are simply too hard for previous file formats to accomplish. For example, a server-side program is able to create a document for someone based on their input, or to create a report on Company A for the time period of Jan. 1, 2004-Dec. 31, 2004.

FIGS. 2a-2c also include relationship types utilized in the file format 24 according to various illustrative embodiments. The relationship types associated with the modular parts not only identify an association or dependency but also identify the basis of the dependency. The relationship types include the following: a code file relationship capable of identifying potentially harmful code files, a user data relationship, a hyperlink relationship, a comments relationship, an embedded object relationship, a drawing object relationship, an image relationship, a mail envelope relationship, a document properties relationship, a thumbnail relationship, a glossary relationship, a chunk relationship, a stylesheet/theme relationship, and a spreadsheet relationship.

Referring to FIG. 2a also illustrates the listing 211 that lists collection types for organizing the modular parts. The collection types include a code collection including the code file part 255, an images collection including the drawing object part 257, and a data part including the user data part 222. The collection types also include an embeddings collection including the embedded object part 251, a fonts collection including the font part 253, and a comments collection including the comments part 220, the footnote part 224, the endnote part 225, the footer part 227, the header part 229, and/or the bibliography part 231.

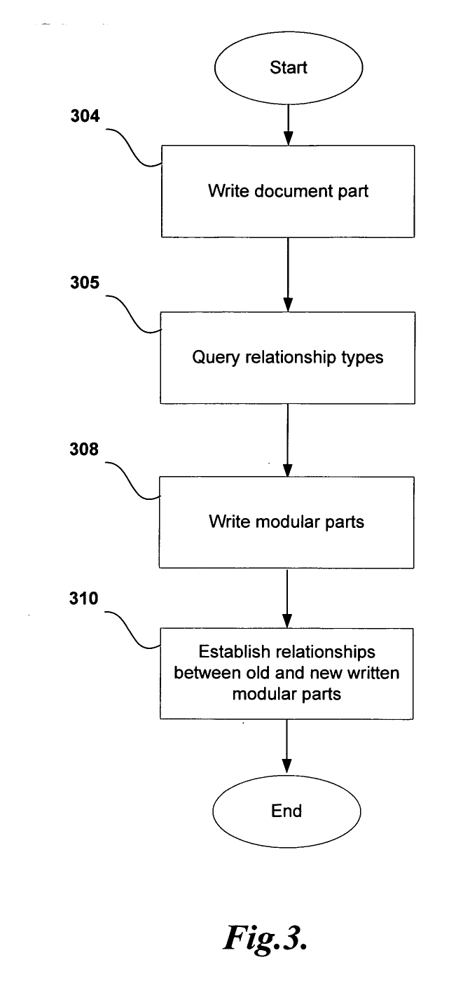

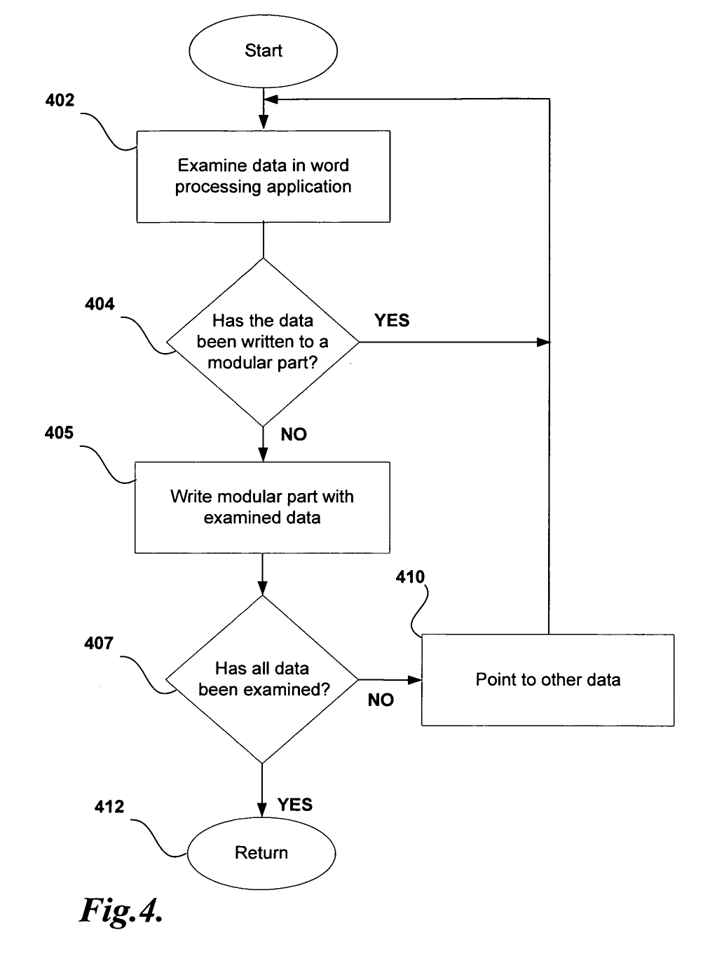

FIGS. 3-5 are illustrative routines performed in representing documents in a modular content framework according to illustrative embodiments. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the implementing computing system. Accordingly, the logical operations illustrated in FIGS. 3-4, and making up the embodiments described herein are referred to variously as operations, structural devices, acts or modules. It will be recognized by one skilled in the art that these operations, structural devices, acts and modules may be implemented in software, in firmware, in special purpose digital logic, and any combination thereof.

Referring now to FIGS. 2a-2c and 3, the routine 300 begins at operation 304, where the word processing application program 10 writes the document part 202. The routine 300 continues from operation 304 to operation 305, where the word processing application program 10 queries the document for relationship types to be associated with modular parts logically separate from the document part but associated with the document part by one or more relationships. Next, at operation 308, the word processing application 10 writes modular parts of the file format separate from the document part. Each modular part is capable of being interrogated separately without other modular parts being interrogated and understood. Any modular part to be shared between other modular parts is typically written only once. The routine 300 then continues to operation 310.

At operation 310, the word processing application 10 establishes relationships between newly written and previously written modular parts. The routine 300 then terminates at the return operation.

Referring now to FIG. 4, the routine 400 for writing modular parts will be described. The routine 400 begins at operation 402 where the word processing application 10 examines data in the word processing application. The routine 400 then continues to detect operation 404 where a determination is made as to whether the data has been written to a modular part. When the data has not been written to a modular part, the routine 400 continues from detect operation 404 to operation 405 where the word processing application writes a modular part including the data examined. The routine 400 then continues to detect operation 407 described below.

When at detect operation 404, the data examined has been written to a modular part, the routine 400 continues from detect operation 404 to detect operation 407. At detect operation 407 a determination is made as to whether all the data has been examined. If all the data has been examined, the routine 400 returns control to other operations at return operation 412. When there is still more data to examine, the routine 400 continues from detect operation 407 to operation 410 where the word processing application 10 points to other data. The routine 400 then returns to operation 402 described above.

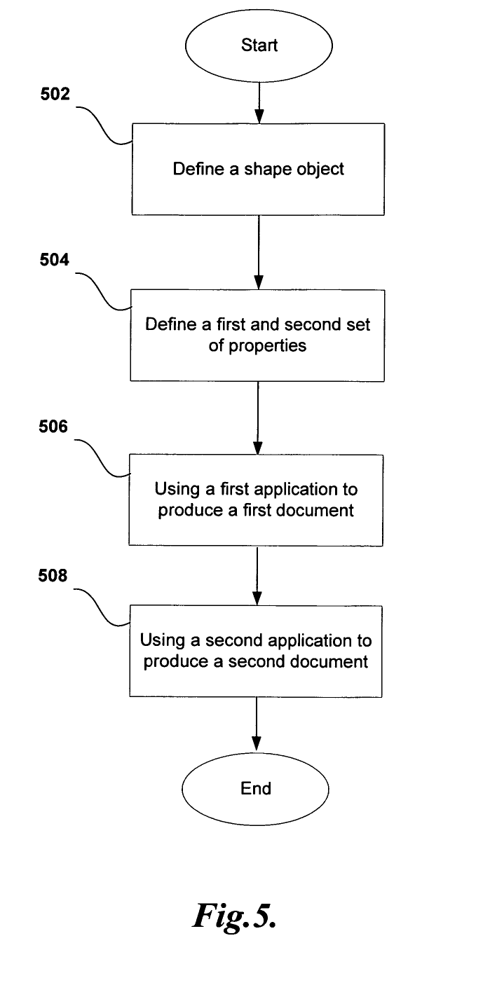

Referring now to FIG. 5, the routine 500 for providing text information in shape objects will be described. The routine 500 begins at operation 502 where the process defines shape object for conveying text runs to a first and second document where each text run has associated properties. At step 504, a first and second set of properties is hierarchically defined for a plurality of text runs so that the first set of properties defines properties for the plurality of text runs, and so that the first set of properties overrides the second set of properties. At step 506, a first application is used to access the shape object to produce a first document. At step 508, the second document is typically created using an application in the application suite that is different from the first application that was used to create the first document. For example, the first document can be created by using a word processor (as described above) and the second document can be created using a spreadsheet program, where the word processor and the spreadsheet can be included in an application suite. Other applications such as database programs and slide authoring programs and the like can be included as well.

Properties can be associated with text runs, individual characters or even other properties, and can be shared and overridden in a hierarchical manner (as discussed briefly above). For example, an application can create a paragraph style (which can be a default collection of properties) that is to be applied to all paragraphs a document. By defining such a style in a single location, it becomes much easier to enforce consistent formatting across a document. Thus, the process for altering the entire look of a document is greatly simplified: desired changes can be made in one location so that the rest of the document automatically reflects the changes.

To provide further flexibility, properties can be overridden locally. When it is desired that a particular paragraph in a document should deviate from a default paragraph style, the specific properties can be specified locally to create an override situation for any (undesired) specified properties. A process (such as a translator, a renderer, a printer, and the like) can resolve both the locally and globally defined properties, with the locally defined properties typically taking precedence over the globally defined properties.

In various embodiments, a user interface (Ul) can be provided for defining (including editing) and/or selecting the shape object. The UI can be used to define text elements such as colors, fonts, and formatting of text runs that are included in the shape object. For example, the shape object can have foreground and background colors. Text can automatically be inset or sized to appropriately fill the shape object such that the entire text run is visible when displaying the shape object.

Additionally, text within the shape object can be controlled through parent objects that encapsulate the (child) shape object. Properties such as color and style can be used to override settings of child objects such that the objects can have a common appearance. For example, bullets (or other formatting) for an outline can be specified at a high level, so that the formatting overrides properties (if any similarly defined properties exist) of the child objects.

Shape objects can also be used to hold content (such as graphics and text runs). The content can then be displayed in documents that access the shape object. When cutting and pasting content (from the shape object or otherwise) displayed in a document, information from any shape object parent objects (or, for example, a pointer to the theme object) can be placed on the clipboard.

The above specification, examples and data provide a complete description of the manufacture and use of embodiments. Since many embodiments can be made without departing from the spirit and scope of the invention, the invention resides in the claims hereinafter appended.

We claim:

1. A computer-implemented method for storing text information in shape objects for documents, comprising:
defining a shape object for conveying text objects to a first and second document, the text runs having properties;
defining a first and second set of properties for a plurality of text objects in a hierarchy so that the first set of properties defines properties for the plurality of text objects, and so that the first set of properties overrides the second set of properties;
using a first application to access the shape object to produce a first document; and
using a second application to access the shape object to produce a second document, the second application producing documents of kinds that are different from the kinds of documents produced by the first application.

2. The method of claim 1 wherein the first and second applications are in an application suite.

3. The method of claim 1 wherein the text run properties comprise information for insetting text within a shape that is displayed in accordance with the shape object.

4. The method of claim 3 wherein the text is inset by sizing the text such that entire text run is visible when displayed within the shape object.

5. The method of claim 1 wherein the text run properties comprise information for controlling overflow characteristics of text within a shape that is displayed in accordance with the shape object.

6. The method of claim 1 wherein the text runs are organized as a bulleted outline.

7. The method of claim 1 wherein the shape object further comprises an encapsulated shape object, wherein the encapsulated shape object inherits text run properties of a parent shape object.

8. The method of claim 1 wherein text run properties in an encapsulated shape object inherit properties from a parent text object that comprises the encapsulated shape object.

9. The method of claim 8 wherein the encapsulated shape object inherits text color properties from a parent text object.

10. The method of claim 1 wherein the first application validates the stored first and second set of text run properties against a schema for text run properties.

11. The method of claim 10 wherein the second application validates the stored first and second set of text run properties against the schema for text run properties.

12. The method of claim 1 further comprising copying parent text run properties of encapsulated text run properties when the encapsulated text run properties are copied to the clipboard.

13. The method of claim 1 wherein the accessing the shape object comprises changing the contents of the shape object.

14. A system for providing text information in shape objects for documents, comprising:
a shape object having associated text bodies to a first and second document, the text bodies having properties;
an operating system for providing an application programmers interface (API) for defining a first and second set of properties for a plurality of text bodies;
a computer readable media for storing the first and second set of properties for text bodies in a hierarchy; so that the first set of properties defines properties for the plurality of text bodies, and so that the first set of properties overrides the second set of properties and
an application suite comprising a first application to access the shape object to produce a first document; and a second application to access the shape object to produce a second document, the second application producing a different kind of document than the first application.

15. The system of claim 16 wherein the first application is a spreadsheet application and the second application is a word processing application.

16. The system of claim 14 wherein the shape object is a parent object to a child object to which the second set of properties is associated.

17. A tangible medium comprising computer-executable instructions for conveying text properties to a plurality of shape objects; comprising:
associating a first set of text properties with a first shape object and a second set of text properties with a second set of text properties in a document, wherein the first shape object is a parent object of the second shape object;
displaying a text run of the second shape object in accordance with the first set of text properties of the first shape object; and
associating the shape object with a first document authored by a word processor application and the shape object with a second document authored by a slide presentation program.

18. The tangible medium of claim 17 the instructions further comprising storing the first, second and third documents in a markup language.

19. The tangible medium of claim 18 wherein the markup language is XML.

20. The tangible medium of claim 20 the instructions further comprising globally defining a default paragraph style in a first ‘part,’ and applying the globally defined default paragraph style in a second ‘part’.
